(19) United States
(12) Patent Application Publication
(10) Pub. No.: US 2026/0061843 A1
(43) Pub. Date: Mar. 5, 2026

(54) INFORMATION DISPLAY DEVICE AND VEHICLE INCLUDING INFORMATION DISPLAY DEVICE

(71) Applicant: KAWASAKI MOTORS, LTD., Akashi-shi (JP)

(72) Inventors: Jiwon SEO, Akashi-shi (JP); Miki NAGASE, Akashi-shi (JP)

(21) Appl. No.: 19/310,722

(22) Filed: Aug. 26, 2025

(30) Foreign Application Priority Data
Aug. 27, 2024 (JP) 2024-145442

(51) Int. Cl. B60K 35/22; B60K 35/28; B60K 35/65

(52) U.S. Cl. CPC B60K 35/22; B60K 35/28; B60K 35/654; B60K 2360/167; B60K 2360/172; B60K 2360/566

(57) ABSTRACT

There are provided an information display device and a vehicle including the information display device. The information display device includes: a display; and a processing circuitry configured to control display of a screen on the display. The processing circuitry is configured to: acquire acceleration information related to acceleration in a traveling direction of a vehicle; acquire rotation angle information related to a rotation angle about a front-rear axis of the vehicle; display a state display element indicating states of both the acceleration and the rotation angle in a predetermined region of the screen; move or deform the state display element in a predetermined direction based on the acceleration information; and rotationally move the state display element based on the rotation angle information.

### CROSS-REFERENCE TO RELATED APPLICATIONS

This application is based on and claims priority under 35 USC 119 from Japanese Patent Application No. 2024-145442 filed on August 27, 2024, the contents of which are incorporated herein by reference.

### TECHNICAL FIELD

The present disclosure relates to an information display device and a vehicle including the same.

### BACKGROUND ART

JP2023-073919A discloses a TFT liquid crystal display as a meter of a motorcycle.

Displaying various pieces of information about a vehicle on a screen is convenient for a user to grasp a state of the vehicle. However, if too much information is displayed on the screen, the entire screen becomes cluttered, and it may become difficult for the user to grasp the state of the vehicle.

### SUMMARY OF INVENTION

Therefore, The present disclosure provides an information display device and a vehicle including the information display device that can make it easy for a user to grasp a state of the vehicle while avoiding cluttering an entire screen.

According to an illustrative aspect of the present disclosure, an information display device includes: a display; and a processing circuitry configured to control display of a screen on the display. The processing circuitry is configured to: acquire acceleration information related to acceleration in a traveling direction of a vehicle; acquire rotation angle information related to a rotation angle about a front-rear axis of the vehicle; display a state display element indicating states of both the acceleration and the rotation angle in a predetermined region of the screen; move or deform the state display element in a predetermined direction based on the acceleration information; and rotationally move the state display element based on the rotation angle information.

According to another illustrative aspect of the present disclosure, a vehicle is configured to incline a body in a turning direction when turning. The vehicle includes: the body; a first sensor fixed to the body and configured to detect information related to the acceleration in the traveling direction of the vehicle; a second sensor fixed to the body and configured to detect information related to the rotation angle about the front-rear axis of the vehicle; and the information display device fixed to the body.

According to the aspect of the present disclosure, it is possible to provide an information display device and a vehicle including the information display device that can make it easy for a user to grasp a state of the vehicle while avoiding cluttering an entire screen.

### BRIEF DESCRIPTION OF DRAWINGS

FIG. 1 is a schematic configuration diagram of a display change system including a vehicle according to a first embodiment;

FIG. 2 is a block diagram showing the configuration of various elements included in the display change system in blocks;

FIG. 3 is a diagram showing an example of a state display screen displayed on a display of an information display device;

FIG. 4 is a diagram illustrating changes in a state display element in accordance with running acceleration and a bank angle of the vehicle;

FIG. 5 is a flowchart showing an example of a flow of display control;

FIG. 6 is a diagram showing an example of a navigation screen displayed on the display of the information display device;

FIG. 7 is a diagram showing a state display screen of the information display device according to a second embodiment, illustrating a state display screen when a vehicle is standing upright;

FIG. 8 is a diagram showing the state display screen of the information display device according to the second embodiment, illustrating a state display screen when the vehicle is banking to the left; and

FIG. 9 is a diagram illustrating changes in a state display element in accordance with running acceleration and a bank angle of the vehicle, different from the changes in the state display element shown in FIG. 4.

### DESCRIPTION OF EMBODIMENTS

Hereinafter, embodiments will be described with reference to the drawings.

### <First Embodiment>

### (Display Change System)

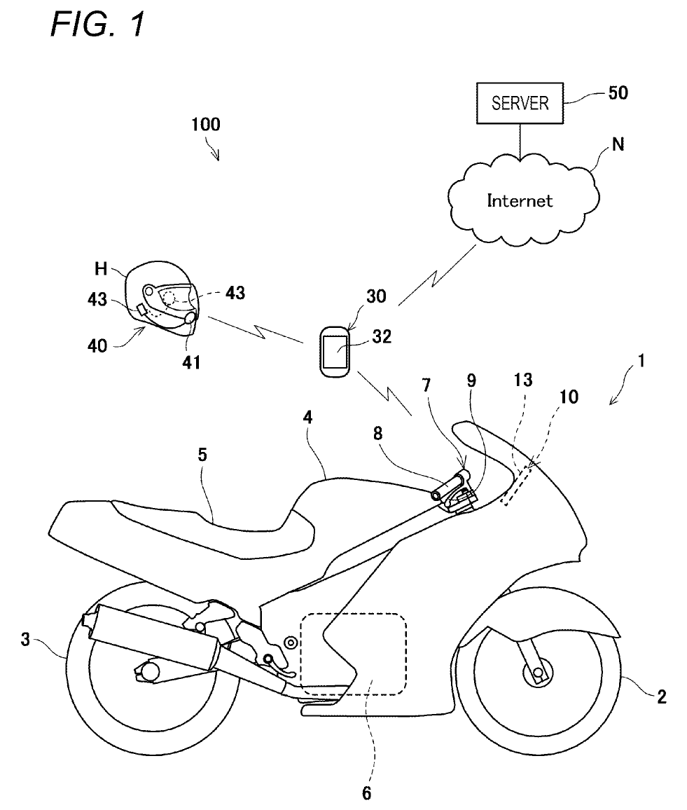

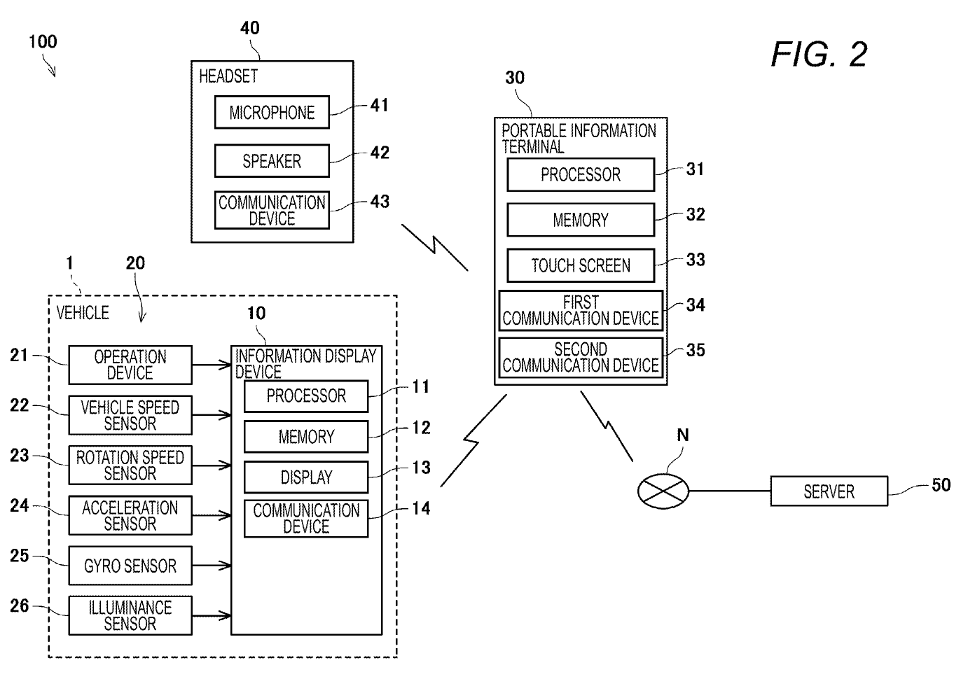

FIG. 1 is a schematic configuration diagram of a display change system 100 including a vehicle 1 according to a first embodiment. FIG. 2 is a block diagram showing the configuration of various elements included in the display change system 100 in blocks. The display change system 100 is a system for changing display of an information display device 10 mounted on the vehicle 1.

The display change system 100 includes the vehicle 1 equipped with the information display device 10, a portable information terminal 30, and a headset 40 that acquires voice uttered by a driver of the vehicle 1. The portable information terminal 30 is attached to the driver or the vehicle 1. For example, the portable information terminal 30 is stored in a pocket of clothes of a driver of the vehicle 1, or the portable information terminal 30 is installed or stored at a predetermined position of the vehicle 1. The portable information terminal 30 is, for example, a smartphone. The headset 40 is attached to a helmet H worn on the head of the driver.

### (Vehicle)

The vehicle 1 is, for example, a motorcycle including a front wheel 2 which is a driven wheel, a rear wheel 3 which is a drive wheel, and a vehicle body 4 supported by the front wheel 2 and the rear wheel 3. A seat 5 on which a driver straddles is supported by the vehicle body 4. The vehicle body 4 can be inclined with respect to a running surface on which the vehicle 1 runs. For example, the vehicle 1 can turn in a state in which the vehicle body 4 is inclined about a front-rear axis passing through a ground contact point of the front wheel 2 and a ground contact point of the rear wheel 3 on the running surface, that is, can turn in a so-called bank state. An inclination angle of the vehicle body 4 about the front-rear axis with the vehicle body 4 standing upright as a reference is a bank angle, and when the vehicle body 4 is in an upright state, the bank angle is zero degrees.

The vehicle 1 includes a prime mover 6 that generates a driving force for running. In the present embodiment, the prime mover 6 is an internal combustion engine. Alternatively, the prime mover 6 may be another type of driving source for running. For example, the prime mover 6 may be an electric motor or a combination of an internal combustion engine and an electric motor. The driving force generated by the prime mover 6 is applied to the rear wheels 3 via a power transmission mechanism. The vehicle 1 includes a hydraulic brake device that brakes the front wheel 2 and the rear wheel 3.

A handlebar 7 is supported on the vehicle body 4. An accelerator operator 8, through which a driver inputs an acceleration command, is disposed on the right side of the handlebar 7. A brake operator 9, through which a driver inputs a braking command, is disposed in front of the accelerator operator 8. For example, the accelerator operator 8 is an accelerator grip supported by the handlebar 7 so as to be rotatable about a rotation axis extending in an extending direction of the handlebar 7. For example, the brake operator 9 is a brake lever supported by the handlebar 7 so as to be rotatable about a rotation axis extending in an upper-lower direction.

The information display device 10 including a display 13 is supported on the vehicle body 4. The display 13 is disposed in front of the handlebar 7 in the vehicle body 4 so as to be visible to the driver. The display 13 is, for example, a thin-film-transistor liquid crystal display (TFT liquid crystal display).

The vehicle 1 includes various sensors or switches. Various sensors or switches mounted on the vehicle 1 are collectively referred to as sensors 20. For example, as shown in FIG. 2, the sensors 20 include an operation device 21, a vehicle speed sensor 22, a rotation speed sensor 23, an acceleration sensor 24, a gyro sensor 25, and an illuminance sensor 26.

The operation device 21 receives an operation from the driver, such as an operation of switching a running mode of the vehicle 1. The operation device 21 may include, for example, one or more switches disposed on the left side of the handlebar 7. For example, the operation device 21 may include a lever or a touch panel.

The vehicle speed sensor 22 detects a running speed of the vehicle 1. For example, the vehicle speed sensor 22 may be a sensor that detects a rotation speed of the front wheel 2.

The rotation speed sensor 23 detects a rotation speed of the prime mover 6. For example, the rotation speed sensor 23 detects a rotation speed of a crankshaft of the internal combustion engine that is the prime mover 6.

The acceleration sensor 24 detects running acceleration of the vehicle 1, that is, acceleration in a front-rear axis direction of the vehicle 1. The running acceleration may also include deceleration.

The gyro sensor 25 detects an angular velocity around the front-rear axis of the vehicle body 4, that is, a bank angular velocity. The acceleration sensor 24 and the gyro sensor 25 may be separate bodies, or may be integrally configured as, for example, a so-called six-axis sensor (inertial measure unit).

The illuminance sensor 26 detects brightness around the illuminance sensor 26, that is, brightness around the vehicle 1.

Each of the sensors 20 is connected to the information display device 10 in a wired or wireless manner. Some or all of the sensors 20 may not be directly connected to the information display device 10, and may be indirectly connected via another in-vehicle device. For example, some or all of the sensors 20 may be connected to the information display device 10 via a vehicle controller or the like for controlling the prime mover 6 supported by the vehicle body 4. The information display device 10 receives detection values of the sensors 20 or information obtained by processing the detection values.

The information display device 10 includes a processor 11, a memory 12, a display 13, and a communication device 14. These elements 11, 12, 13, 14 are electrically connected to each other. The processor 11 controls the operation of the information display device 10. For example, the processor 11 controls display of the display 13 such that various types of information indicating the state of the vehicle 1 are displayed based on the received information. The display control by the processor 11 will be described in detail later.

The memory 12 does not need to be a single storage device, and may be implemented by a plurality of storage devices. For example, the memory 12 may be one of a plurality of types of storage devices such as a RAM, a ROM, a hard disk, and a flash memory, or may be implemented by a combination of two or more storage devices. For example, various operations of the information display device 10 are implemented by the processor 11 executing a program stored in the memory 12. The processor 11 and the memory 12 are examples of a processing circuitry.

The communication device 14 is a wireless communication device that performs wireless communication by predetermined short-range wireless communication. Therefore, the information display device 10 is a meter device having a wireless communication function. The communication device 14 is configured to communicate with the portable information terminal 30. The communication device 14 includes an antenna, a radio frequency (RF) circuit, and the like. The short-range wireless communication is, for example, Bluetooth (registered trademark).

The information display device 10 may not include the communication device 14. For example, a communication device capable of communicating with the portable information terminal 30 may be located outside the information display device 10, and the information display device 10 may communicate with the portable information terminal 30 via the communication device. The information display device 10 and the portable information terminal 30 may be connected to each other by wire.

### (Portable Information Terminal)

The portable information terminal 30 includes a processor 31, a memory 32, a touch screen 33, a first communication device 34, and a second communication device 35. These elements 31, 32, 33, 34, 35 are electrically connected to each other.

The processor 31 controls the operation of the portable information terminal 30. The memory 32 does not need to be a single storage device, and may be implemented by a plurality of storage devices. For example, the memory 32 may be one of a plurality of types of storage devices such as a RAM, a ROM, and a flash memory, or may be implemented by a combination of two or more storage devices. For example, various operations of the portable information terminal 30 are implemented by the processor 31 executing a program stored in the memory 32. For example, the processor 31 executes a well-known voice recognition process to perform an action in accordance with the speech of the driver.

The first communication device 34 is a wireless communication device that performs wireless communication by predetermined short-range wireless communication. The first communication device 34 is configured to communicate with the communication device 14 of the vehicle 1 and a communication device 43 of the headset 40. Since the first communication device 34 and the communication device 43 of the headset 40 have the same configuration as the communication device 14, the description thereof will be omitted.

The headset 40 includes a microphone 41, a speaker 42, and the communication device 43. The microphone 41 and the speaker 42 are electrically connected to the communication device 43. The voice uttered by the driver is converted into an electric signal by the microphone 41 and transmitted to the portable information terminal 30 by the communication device 43. A voice signal received by the communication device 43 from the portable information terminal 30 is converted into sound by the speaker 42 and output to the driver.

The second communication device 35 is a module having a communication circuit for connecting to the Internet N. For example, the second communication device 35 is a wireless LAN module. For example, the second communication device 35 is connected to the Internet N via a public wireless line. The second communication device 35 communicates with a server 50 via connected Internet N.

In the present embodiment, the server 50 may be, for example, a cloud server that provides a navigation service that searches for a route to a designated destination and provides guidance on the route. The server 50 includes, for example, a processor, a memory, and a communication device. When the processor of the server 50 receives from the portable information terminal 30 inquiry information regarding an inquiry about the route to the destination, the processor sends navigation information to the portable information terminal 30 as a response to the inquiry information. The inquiry information includes destination information indicating a destination and current location information indicating a current location of the portable information terminal 30 or the vehicle 1. For example, the portable information terminal 30 includes a global positioning system (GPS) receiver, and the current location information may be acquired by a GPS function.

### (Display Control)

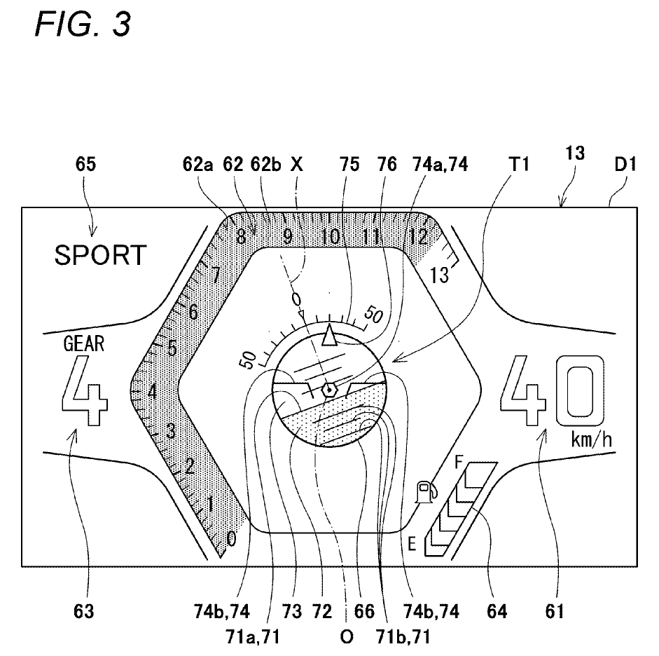

FIG. 3 is a diagram showing an example of a state display screen D1 displayed on the information display device 10. The processor 11 displays the state display screen D1 on the display 13. The state display screen D1 includes a vehicle speed display region 61, a rotation speed display region 62, a gear stage display region 63, a remaining fuel amount display region 64, a running mode display region 65, and a state display region 66.

In the vehicle speed display region 61, the vehicle speed of the vehicle 1 is displayed. In the rotation speed display region 62, the rotation speed of the prime mover 6 is displayed. In the gear stage display region 63, a gear stage, that is, a gear position is displayed. In the remaining fuel amount display region 64, an amount of remaining fuel in the prime mover 6 is displayed. In the running mode display region 65, a currently set running mode is displayed.

The rotation speed display region 62 extends along an outer periphery of the state display region 66 described later. More specifically, the rotation speed display region 62 extends from a lower left part of the state display region 66, through an upper left part of the state display region 66, to an upper right part of the state display region 66 in the state display screen D1. The rotation speed display region 62 includes scale lines 62a arranged in an extending direction of the rotation speed display region 62 and an indicator element 62b that is a display element associated with the rotation speed of the prime mover 6 on the scale lines 62a. In the present embodiment, the indicator element 62b is a bar extending from the scale line 62a corresponding to zero to a position corresponding to the rotation speed of the prime mover 6. The indicator element 62b is not limited thereto. For example, the indicator element 62b may be a needle-shaped display element that points to a position in the rotation speed display region 62 that corresponds to the rotation speed of the prime mover 6.

A state display indicator T1 is displayed in the center of the state display screen D1. The state display indicator T1 is a graphic indicator that shows states of both the running acceleration and the bank angle of the vehicle 1. The state display indicator T1 is implemented by combining a plurality of elements.

The state display indicator T1 includes, as constituent elements, the state display region 66 and a state display element 71 that moves or deforms within the state display region 66 depending on both the running acceleration and the bank angle of the vehicle 1.

The state display region 66 is a circular region. The state display region 66 is located in the center of the state display screen D1. The state display element 71 is arranged in the state display region 66.

The state display element 71 indicates the state of the running acceleration of the vehicle 1, whether the vehicle 1 is accelerating, decelerating, or neither accelerating nor decelerating. The state of the running acceleration of the vehicle 1 may include the magnitude of the acceleration. In the present specification, the term "traveling acceleration" may include not only the acceleration in a traveling direction of the vehicle 1, but also the acceleration in an opposite direction to the traveling direction, that is, the concept of deceleration. For example, when the vehicle 1 accelerates in the traveling direction, the running acceleration may be defined by a positive value, and when the vehicle 1 decelerates, the running acceleration may be defined by a negative value.

The state display element 71 indicates whether the state of the bank angle of the vehicle 1 is a state in which the vehicle body 4 is upright, a state in which the vehicle body 4 is banking to the right, or a state in which the vehicle body 4 is banking to the left. The state of the bank angle of the vehicle 1 may include the magnitude of the bank angle. In the present specification, the term "bank angle" may include a concept of a bank direction. For example, when the vehicle body 4 is inclined to one of the right side and the left side, the bank angle may be defined as a positive value, and when the vehicle body 4 is inclined to the other side, the bank angle may be defined as a negative value.

The state display element 71 includes a boundary 71a that divides the state display region 66 into a first region 72 and a second region 73. The boundary 71a is a straight line. More specifically, the boundary 71a extends linearly in a direction perpendicular to a virtual axis X, which will be described later. The first region 72 is a region below the boundary 71a in the state display region 66, and the second region 73 is a region above the boundary 71a in the state display region 66.

The first region 72 and the second region 73 are displayed in different colors with each other. The processor 11 may change the color of one or both regions of the first region 72 and the second region 73 in accordance with, for example, a detection value of the illuminance sensor 26.

The state display element 71 includes a plurality of auxiliary scale lines 71b parallel to the linear boundary 71a. The number of auxiliary scale lines 71b below the boundary 71a among the plurality of auxiliary scale lines 71b may be the same as the number of auxiliary scale lines 71b above the boundary 71a among the plurality of auxiliary scale lines 71b. The boundary 71a and the plurality of auxiliary scale lines 71b are arranged at equal intervals. More specifically, the boundary 71a and the plurality of auxiliary scale lines 71b are arranged at equal intervals in the extending direction of the virtual axis X described later.

The processor 11 moves or deforms the state display element 71 in the state display region 66 in accordance with the running acceleration of the vehicle 1 and the bank angle of the vehicle 1. Specifically, the processor 11 acquires acceleration information related to the running acceleration of the vehicle 1. For example, the acceleration information is a detection value of the acceleration sensor 24. The processor 11 moves the state display element 71 in a direction along the predetermined virtual axis X in the state display region 66 based on the acceleration information. The virtual axis X is indicated by a one-dot chain line in FIG. 3. The virtual axis X is an invisible axis that is not displayed on the display 13. The virtual axis X passes through a predetermined point O on the state display screen D1 and extends linearly.

The processor 11 acquires rotation angle information related to the bank angle, which is a rotation angle about the front-rear axis of the vehicle 1. In other words, the rotation angle information is information related to the inclination angle of the vehicle body 4 about the front-rear axis with respect to the running surface of the vehicle 1. For example, the processor 11 acquires the rotation angle information by calculating the bank angle, which is the rotation angle about the front-rear axis from the upright state of the vehicle body 4, based on the angular velocity detected by the gyro sensor 25. The rotation angle information includes not only information on the magnitude of the bank angle but also information on the bank direction.

The processor 11 rotationally moves the virtual axis X and the state display element 71 based on the rotation angle information. Specifically, the processor 11 rotationally moves the virtual axis X and the state display element 71 about the predetermined point O based on the rotation angle information. The predetermined point O may also be referred to as a rotation center O. As described above, the rotation center O is a point through which the virtual axis X passes. In the present embodiment, similarly to the virtual axis X, the rotation center O is an invisible point that is not displayed on the display 13. The rotation center O is located at the center of the state display region 66, that is, the center of the circumference that defines the state display region 66.

The processor 11 displays one or more reference display elements 74 on the state display screen D1. The one or more reference display elements 74 are constituent elements of the state display indicator T1. The one or more reference display elements 74 indicate a reference position of the state display element 71 when the running acceleration of the vehicle 1 is zero. The one or more reference display elements 74 do not move in accordance with at least a change in the acceleration of the vehicle 1. In the present embodiment, the one or more reference display elements 74 do not move in accordance with a change in the bank angle of the vehicle 1 either. The one or more reference display elements 74 include a first reference element 74a and two second reference elements 74b.

The first reference element 74a is a figure positioned at the rotation center O. When the running acceleration of the vehicle 1 is zero, the boundary 71a passes through the first reference element 74a. In the present embodiment, the first reference element 74a has a hexagonal shape, but the shape is not limited thereto. The first reference element 74a may be, for example, a circle or a point. The first reference element 74a may be any element that allows the driver to grasp the position of the rotation center O on the state display screen D1.

The two second reference elements 74b are disposed on both sides of the first reference element 74a in a left-right direction. Each second reference element 74b has a straight line extending in the left-right direction, and the straight line overlaps the boundary 71a when the running acceleration of the vehicle 1 is zero and the bank angle of the vehicle 1 is zero. That is, the second reference elements 74b indicate the position of the boundary 71a when the running acceleration of the vehicle 1 is zero and the bank angle of the vehicle 1 is zero.

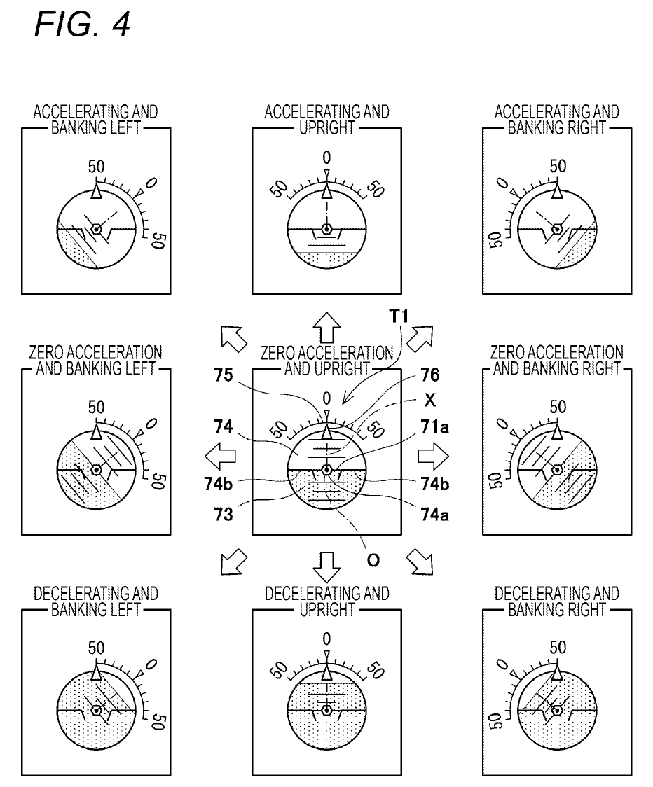

Changes of the state display element 71 will be described in detail with reference to FIG. 4. FIG. 4 is a diagram illustrating changes in the state display element 71 in accordance with the running acceleration and the bank angle of the vehicle 1. FIG. 4 shows nine state display indicators T1 which differ in at least one of the running acceleration and the bank direction of the vehicle 1. In FIG. 4, the nine state display indicators T1 are arranged in an array of three rows and three columns.

In FIG. 4, the three state display indicators T1 in the middle in the upper-lower direction represent states in which the running acceleration is zero, the three state display elements 71 on the upper side in the upper-lower direction represent states in which the running acceleration is positive, and the three state display indicators T1 on the lower side in the upper-lower direction represent states in which the running acceleration is negative. A state in which the running acceleration is zero refers to a state in which the vehicle 1 is stopped or running at a constant speed. As can be seen from the three state display indicators T1 in the middle in the upper-lower direction, the boundary 71a passes through the rotation center O in a state where the running acceleration is zero.

In FIG. 4, the three state display indicators T1 in the middle in the left-right direction represent states in which the bank angle is zero degrees, the three state display indicators T1 on the left side in the left-right direction represent states in which the vehicle body 4 is banking to the left side, and the three state display indicators T1 on the right side in the left-right direction represent stated in which the vehicle body 4 is banking to the right side. A state in which the bank angle is zero degrees is a state in which the vehicle 1 is stopped or running in an upright position. As can be seen from the three state display elements 71 in the middle in the left-right direction, in a state where the bank angle is zero, the virtual axis X extends linearly on a plane that passes through the rotation center O and is perpendicular to the left-right direction. A direction toward the upper side along the virtual axis X may be referred to as a positive direction of the virtual axis X, and a direction opposite thereto, that is, a direction toward the lower side along the virtual axis X may be referred to as a negative direction of the virtual axis X.

The processor 11 moves the state display element 71 in the direction along the virtual axis X based on the acceleration information. For example, when the running acceleration is zero, the processor 11 positions the boundary 71a so that the boundary 71a passes through the rotation center O. Therefore, when the running acceleration is zero, the boundary 71a passes through the first reference element 74a. For example, when the running acceleration is a positive value, the processor 11 moves the state display element 71 in the negative direction of the virtual axis X, which is one side in the direction along the virtual axis X, and when the running acceleration has a negative value, moves the state display element 71 in the positive direction of the virtual axis X, which is the other side in the direction along the virtual axis X. More specifically, when the running acceleration is a positive value, the processor 11 moves the boundary 71a in the negative direction of the virtual axis X from the rotation center O, for example, from the first reference element 74a located at the rotation center O. When the running acceleration is a negative value, the processor 11 moves the boundary 71a in the positive direction of the virtual axis X from the rotation center O, for example, from the first reference element 74a located at the rotation center O.

Based on the rotation angle information, the processor 11 rotates the virtual axis X and the state display element 71 about the rotation center O in the same direction and by the same angle as the rotation of the vehicle 1 about the front-rear axis. For example, when the vehicle body 4 is inclined by 50 degrees to the right, the processor 11 rotates the virtual axis X and the state display element 71 on the state display screen D1 by 50 degrees clockwise, which is a direction corresponding to the inclination of the vehicle body 4, about the rotation center O.

When the bank angle is zero and the running acceleration is zero, the processor 11 positions the boundary 71a of the state display element 71 as the second reference elements 74b. That is, when the running acceleration of the vehicle 1 is zero and the bank angle of the vehicle 1 is zero, the boundary 71a is positioned so as to overlap the straight lines extending in the left-right direction of the second reference elements 74b. Since the straight line extending in the left-right direction of each second reference element 74b does not move in accordance with the bank angle, the larger the bank angle, the larger the inclination angle of the boundary 71a with respect to the straight line extending in the left-right direction of each second reference element 74b. Therefore, by checking the degree of inclination between the second reference elements 74b and the boundary 71a, the driver can easily grasp the inclination of the vehicle body 4.

As a result of the movement of the state display element 71, a portion of the state display element 71 that deviates from the state display region 66 becomes invisible.

Returning to FIG. 3, the processor 11 displays a rotation angle scale 75 arranged along a rotation direction of the state display element 71 above the state display region 66 in the state display screen D1, and an indicator element 76 indicating a position corresponding to the rotation angle about the front-rear axis of the vehicle 1 in the rotation angle scale 75. The rotation angle scale 75 and the indicator element 76 are constituent elements of the state display indicator T1. The processor 11 rotationally moves the rotation angle scale 75 together with the state display element 71 about the rotation center O based on the rotation angle information. The indicator element 76 is fixed. Therefore, the driver can grasp the magnitude of the bank angle by checking a relative position between the rotation angle scale 75 and the indicator element 76. Alternatively, the rotation angle scale 75 may be fixed, and the processor 11 may rotate the indicator element 76 about the rotation center O based on the rotation angle information.

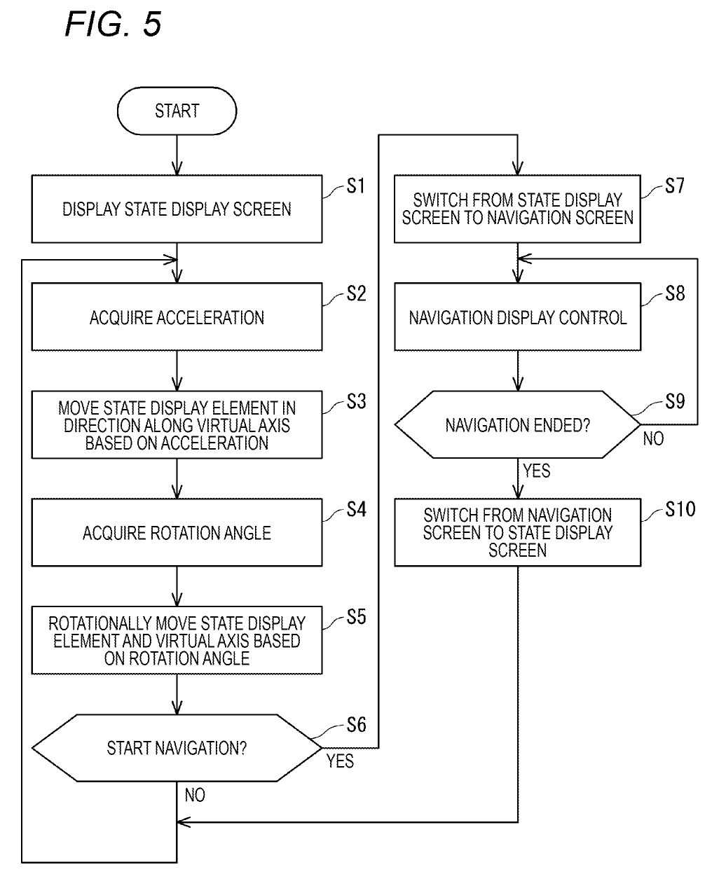

Next, a flow of display control in the information display device 10 will be described with reference to FIG. 5. As shown in FIG. 5, first, the processor 11 displays the state display screen D1 (step S1).

While the state display screen D1 is displayed, the processor 11 acquires acceleration information (step S2), and moves the state display element 71 in the direction along the virtual axis X based on the acceleration information (step S3). The processor 11 acquires the rotation angle information (step S4), and rotationally moves the state display element 71 and the virtual axis X about the rotation center O based on the rotation angle information (step S5).

After step S5, the processor 11 determines whether a navigation start instruction is acquired (step S6). When it is determined that the navigation start instruction is acquired (step S6: No), the processor 11 proceeds to step S2. That is, as long as there is no instruction to start navigation, steps S2, S3, S4, and S5 are repeated. Therefore, the state display element 71 moves in real time in accordance with a change in the running acceleration and a change in the bank angle of the vehicle 1.

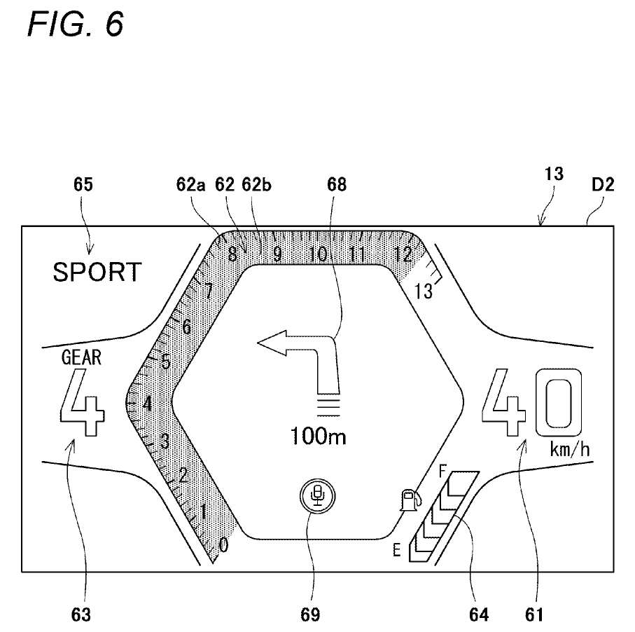

In step S6, when the processor 11 determines that the navigation start instruction is acquired (step S6: Yes), the processor 11 switches a screen displayed on the display 13 from the state display screen D1 to a navigation screen D2 as illustrated in FIG. 6 (step S7). While the navigation screen D2 is displayed, the processor 11 executes navigation display control to guide the vehicle 1 (step S8).

FIG. 6 is a diagram showing an example of the navigation screen D2 displayed on the display 13 of the information display device 10. The navigation screen D2 includes the vehicle speed display region 61, the rotation speed display region 62, the gear stage display region 63, the remaining fuel amount display region 64, the running mode display region 65, and a guidance image display region 68. Since the regions 61, 62, 63, 64, and 65 are the same as those of the state display screen D1, the description thereof will be omitted.

The guidance image display region 68 is located in the center of the navigation screen D2. In the guidance image display region 68, an image related to navigation, such as an image for guiding the vehicle 1 from a current location to a destination, is displayed. A voice recognition state icon 69 is located, for example, below the guidance image display region 68.

The navigation screen D2 includes the voice recognition state icon 69. The voice recognition state icon 69 may also be included in the state display screen D1. The voice recognition state icon 69 indicates a state of the voice recognition process in the portable information terminal 30. The processor 11 displays the voice recognition state icon 69 in different display modes in accordance with the state of the voice recognition process in the portable information terminal 30.

For example, a state of the voice recognition process includes a startup waiting state, an utterance acceptance state, and a response preparation state. The startup waiting state is a state in which the voice recognition process is not yet started. The utterance acceptance state is a state after the start of the voice recognition process and is a state in which the utterance of the driver is accepted. The response preparation state is a state in which a response to the received utterance is prepared. For example, when the state of the voice recognition process is the startup waiting state, the voice recognition state icon 69 is not displayed. For example, when the state of the voice recognition process is the utterance acceptance state, the voice recognition state icon 69 is displayed as an illustrated image of a microphone. For example, when the state of the voice recognition process is the response preparation state, the voice recognition state icon 69 is displayed as an illustrated image of a microphone surrounded by a circle. The display mode of the voice recognition state icon 69 is not limited thereto, and for example, the color of the voice recognition state icon 69 may be changed, or the voice recognition state icon 69 may be lit or blinked in accordance with the state of the voice recognition process.

An example of the navigation display control in the information display device 10 and the voice recognition process in the portable information terminal 30 will be described.

A start command, which is a word for starting the voice recognition process, is registered in advance in the memory 32 of the portable information terminal 30. When the driver utters the start command, the start command is acquired through the microphone 41 of the headset 40 and sent to the portable information terminal 30. In the portable information terminal 30, the processor 31 starts the voice recognition process based on the received start command.

When the processor 31 starts the voice recognition process, the processor 31 receives the utterance of the driver. The processor 31 sends information indicating the utterance acceptance state to the information display device 10 of the vehicle 1. In the information display device 10, the processor 11 switches the display mode of the voice recognition state icon 69 to the display mode corresponding to the utterance acceptance state. In the present embodiment, the information indicating the utterance acceptance state includes the navigation start instruction. That is, the voice recognition state icon 69 is displayed in the display mode corresponding to the utterance acceptance state, and the state display screen D1 is switched to the navigation screen D2.

When the driver utters a phrase inquiring about a route to a certain destination, the voice is picked up by the microphone 41 of the headset 40 and sent to the portable information terminal 30. In the portable information terminal 30, the processor 31 converts the received voice signal into text data. The processor 31 sends the text data obtained by converting as inquiry information to the server 50 via the Internet. The processor 31 sends information indicating the response preparation state to the information display device 10 of the vehicle 1. In the information display device 10, the processor 11 switches the display mode of the voice recognition state icon 69 to the display mode corresponding to the response preparation state.

The server 50 generates navigation information as a response to the inquiry information and sends the navigation information to the portable information terminal 30. The navigation information includes information on a route to the destination. When the portable information terminal 30 receives the navigation information, the processor 31 executes the navigation control. For example, based on the navigation information, the processor 31 sends voice information to the headset 40 to guide the driver to the destination, such as "About 100 meters ahead, turn right." For example, the processor 31 sends to the information display device 10 an instruction for an image to be displayed in the guidance image display region 68 based on the navigation information. In the information display device 10, the processor 11 displays an image in the guidance image display region 68 based on the received instruction. Further, the processor 11 switches the display mode of the voice recognition state icon 69 to a display mode corresponding to the startup waiting state.

Returning to FIG. 5, while the navigation screen D2 is displayed, the processor 11 determines whether a navigation end condition is satisfied (step S9). When the processor 11 determines that the navigation end condition is not satisfied (step S9: No), the processor 11 continues the navigation display control. The navigation end condition may include, for example, a condition that the position of the vehicle 1 has reached the destination. The navigation end condition may include, for example, a condition that the image in the guidance image display region 68 is displayed for a predetermined period of time.

When the processor 11 determines that the navigation end condition is satisfied (step S9: Yes), the processor 11 switches the screen displayed on the display 13 from the navigation screen D2 to the state display screen D1 (step S10), and proceeds to step S2.

### (Operation and Effect)

As described above, according to the present embodiment, both the running acceleration and the rotation angle about the front-rear axis of the vehicle 1 are displayed on the screen of the display 13 by the state display element 71, so that the screen of the display 13 can be prevented from becoming cluttered as compared with a case where the acceleration of the vehicle 1 and the rotation angle about the front-rear axis of the vehicle 1 are separately displayed. According to the present embodiment, on the screen of the display 13, the running acceleration of the vehicle 1 is represented by the movement of the state display element 71 in the direction along the predetermined virtual axis X, and the rotation angle of the vehicle 1 about the front-rear axis is represented by the rotation of the state display element 71, so that the user can intuitively grasp the state of the vehicle 1 from the changes in the state display element 71.

According to the present embodiment, the processor 11 moves the state display element 71 in the direction along the virtual axis X based on the acceleration information and rotationally moves the virtual axis X and the state display element 71 about the rotation center O through which the virtual axis X passes based on the rotation angle information, so that the user can more easily grasp the state of the running acceleration and the state of the bank angle of the vehicle 1.

According to the present embodiment, the state display element 71 divides the state display region 66 in the state display screen D1 into the first region 72 and the second region 73 and includes the boundary 71a that intersects the virtual axis X, so that both the acceleration and the rotation angle about the front-rear axis of the vehicle 1 can be expressed by simple elements.

According to the present embodiment, the first region 72 and the second region 73 are displayed in different colors, so that the state of the running acceleration of the vehicle 1 can be grasped from the size of the area of each region. Therefore, it is easy to grasp the state of the running acceleration of the vehicle 1.

According to the present embodiment, the state display region 66 is circular and the rotation center of the rotation movement of the state display element 71 is the center of the circle that is an outer edge of the state display region 66, so that it is easy to visually distinguish the state display element 71 from other display elements on the screen D1.

According to the present embodiment, the state display region 66 is located in the center of the state display screen D1, so that the state display element 71 is easily visually recognized.

According to the present embodiment, the rotation speed display region 62 is arranged on an outer periphery extending along the outer periphery of the state display region, so that a region around the region in which the state display element 71 is displayed in the state display screen D1 can be effectively used.

According to the present embodiment, the reference display element 74, which indicates the position of the state display element 71 when the acceleration in the traveling direction of the vehicle is zero, is displayed on the state display screen D1, so that it is possible to determine whether the vehicle 1 is accelerating, decelerating, or running at a constant speed based on the positional relationship between the state display element 71 and the reference display element 74.

According to the present embodiment, the processor 11 rotationally moves the rotation angle scale 75 together with the state display element 71 based on the rotation angle information, so that it is easy to grasp the rotation angle about the front-rear axis of the vehicle 1.

### (Second Embodiment)

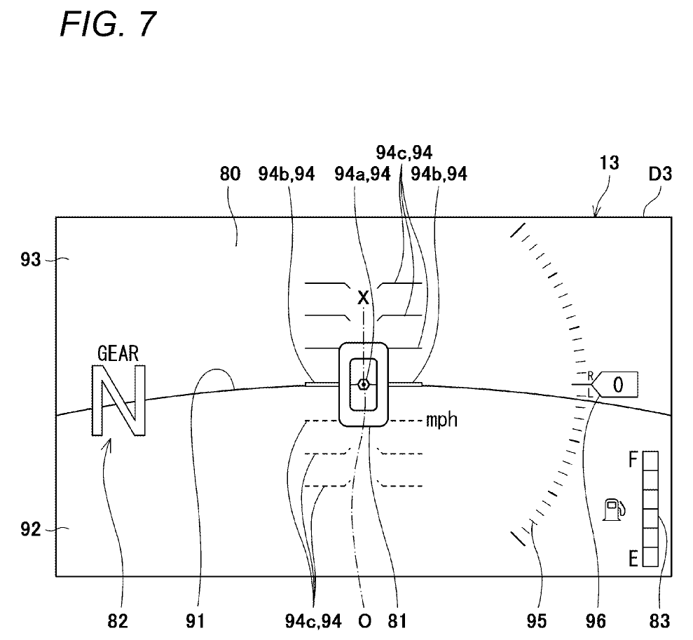

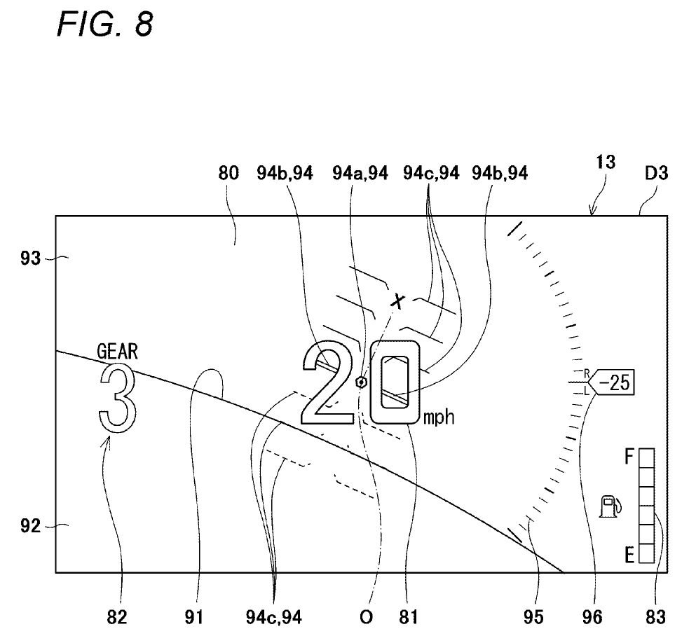

A state display screen D3 of the information display device 10 according to the second embodiment will be described with reference to FIGS. 7 and 8. FIG. 7 shows a state display screen D3 when the vehicle 1 is standing upright, and FIG. 8 shows the state display screen D3 when the vehicle 1 is banking to the left. In the second embodiment, only the state display screen is different from that of the first embodiment, and the description of the hardware configuration is omitted.

As illustrated in FIG. 7, the processor 11 displays a background image 80 on the display 13, and displays various types of information on the background image 80 in a superimposed manner. Specifically, the processor 11 acquires vehicle parameter information indicating parameters related to the vehicle 1 other than the acceleration and the rotation angle, and displays the acquired vehicle parameters on the background image 80 in a superimposed manner. The vehicle parameters include, for example, a vehicle speed, a rotation speed of the prime mover 6, a gear position, and an amount of remaining fuel of the prime mover 6. For example, an image 81 indicating the vehicle speed, an image 82 indicating the gear position, a remaining fuel amount image 83 indicating the amount of remaining fuel of the prime mover 6, and the like are displayed on the background image 80 in a superimposed manner.

The background image 80 is divided into a first region 92 and a second region 93 by a boundary 91. In the present embodiment, the boundary 91 is a state display element that indicates the states of both the running acceleration and the bank angle of the vehicle 1. The boundary 91 extends in the left-right direction when the running acceleration is zero. The first region 92 is a region below the boundary 91 in the background image 80, and the second region 93 is a region above the boundary 91 in the background image 80.

The processor 11 moves the boundary 91 in a direction along the predetermined virtual axis X based on the acceleration information. The virtual axis X is indicated by a one-dot chain line in FIGS. 7 and 8. The virtual axis X is an invisible axis that is not displayed on the display 13. The virtual axis X passes through a predetermined rotation center O on the state display screen D3 and extends linearly. As shown in FIG. 7, in a state where the bank angle is zero, the virtual axis X extends linearly on a plane that passes through the rotation center O and is perpendicular to the left-right direction. The rotation center O is located in the center of the state display screen D3, for example. A direction toward the upper side along the virtual axis X may be referred to as a positive direction of the virtual axis X, and a direction opposite thereto, that is, a direction toward the lower side along the virtual axis X may be referred to as a negative direction of the virtual axis X.

The processor 11 displays one or more reference display elements 94 on the state display screen D3. The one or more reference display elements 94 indicate a reference position of the boundary 91 when the running acceleration of the vehicle 1 is zero. The one or more reference display elements 94 do not move in accordance with a change in the acceleration of the vehicle 1, but rotate about the rotation center O in accordance with a change in the bank angle of the vehicle 1. The one or more reference display elements 94 include a first reference element 94a, two second reference elements 94b, and a plurality of third reference elements 94c.

The first reference element 94a is a figure positioned at the rotation center O. When the running acceleration of the vehicle 1 is zero, the boundary 91 passes through the first reference element 94a.

The two second reference elements 94b are disposed on both sides of the first reference element 94a in a left-right direction. Each second reference element 94b is linear and overlaps the boundary 91 when the running acceleration of the vehicle 1 is zero. That is, the second reference elements 94b indicate the position of the boundary 91 when the running acceleration of the vehicle 1 is zero.

The plurality of third reference elements 94c are parallel to the linear second reference elements 94b. The plurality of third reference elements 94c are arranged at equal intervals in the positive direction and the negative direction of the virtual axis X from the second reference elements 94b. The plurality of third reference elements 94c serve as scales for measuring the magnitude of the running acceleration of the vehicle 1.

The processor 11 moves the boundary 91 in the direction along the virtual axis X based on the acceleration information. For example, when the running acceleration is zero, the processor 11 positions the boundary 91 so that the boundary 91 passes through the rotation center O. Therefore, when the running acceleration is zero, the boundary 91 passes through the first reference element 94a. When the running acceleration is a positive value, the processor 11 moves the boundary 91 in the negative direction of the virtual axis X, which is one side in the direction along the virtual axis X from the rotation center O, for example, from the first reference element 94a located at the rotation center O. When the running acceleration is a negative value, the processor 11 moves the boundary 91 in the positive direction of the virtual axis X, which is the other side in the direction along the virtual axis X from the rotation center O, for example, from the first reference element 94a located at the rotation center O.

Based on the rotation angle information, the processor 11 rotates the virtual axis X, the boundary 91, and the one or more reference display elements 94 about the rotation center O in the same direction and by the same angle as the rotation of the vehicle 1 about the front-rear axis. For example, when the vehicle body 4 is inclined by 50 degrees to the right, the processor 11 rotates the virtual axis X, the boundary 91, and the one or more reference display elements 94 on the state display screen D3 by 50 degrees clockwise, which is a direction corresponding to the inclination of the vehicle body 4, about the rotation center O. Unlike the first embodiment, in the second embodiment, since the second reference elements 94b also rotate together with the boundary 91, when the running acceleration is zero, the boundary 91 is positioned at the second reference elements 94b regardless of the value of the bank angle.

The processor 11 displays a rotation angle scale 95 arranged in a rotation direction of the boundary 91 in a region on the right of the one or more reference display elements 94 on the state display screen D3. Since the position of the boundary 91 that is the state display element in the rotation angle scale 95 changes in accordance with a change in the bank angle, the driver can intuitively grasp a bank direction and the magnitude of the bank angle by viewing a relative position between the rotation angle scale 95 and the boundary 91.

Further, a rotation angle display region 96 is arranged in the center of the rotation angle scale 95 on the state display screen D3. In the rotation angle display region 96, the bank angle is displayed as a numerical value. Therefore, the driver can specifically grasp the magnitude of the bank angle by viewing the numerical value in the rotation angle display region 96.

### (Other Embodiments)

The present disclosure is not limited to the embodiments described above, and the configuration can be modified, added, or deleted.

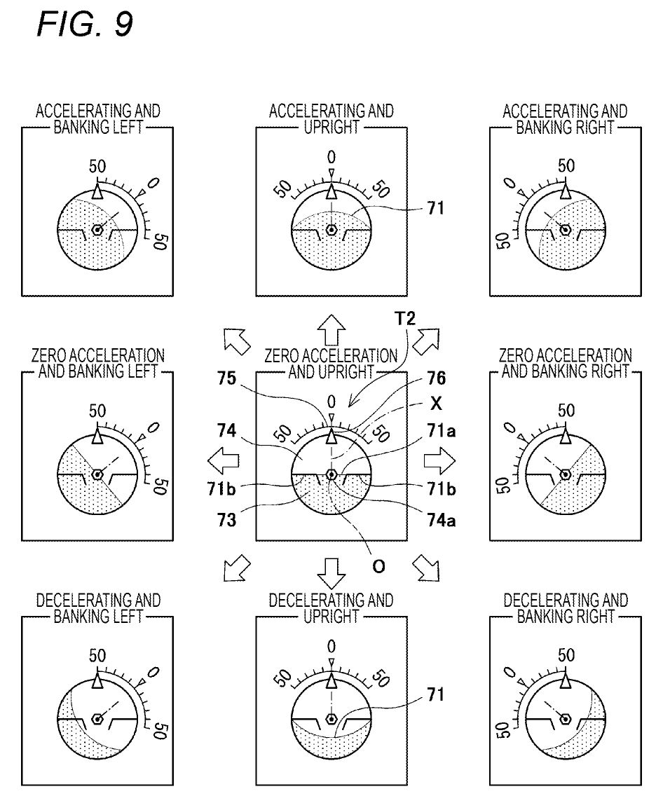

In the above embodiments, the processor 11 moves the state display element 71 in the direction along the virtual axis X based on the acceleration information. Alternatively, the processing circuitry of the information display device may deform the state display element in a direction along a predetermined virtual axis. An example of deforming the state display element in the direction along the predetermined virtual axis will be described with reference to FIG. 9.

FIG. 9 is a diagram illustrating changes in a state display element in accordance with the running acceleration and the bank angle of the vehicle, different from the changes in the state display element shown in FIG. 4. A state display indicator T2 shown in FIG. 9 is substantially the same as the state display indicator T1 shown in FIG. 4, and description of the same elements will be omitted. The state display indicator T2 includes the boundary 71a as the state display element 71. The state display indicator T2 includes the first reference element 74a and two second reference elements 74b. When the running acceleration is zero, the boundary 71a is a straight line. In the examples shown in FIG. 9, the processor 11 also rotationally moves the virtual axis X and the state display element 71 about the predetermined point O based on the rotation angle information. However, unlike the above embodiment, in this embodiment, the processor 11 deforms, based on the acceleration information, the state display element 71 in the direction along the virtual axis X instead of moving the state display element 71 in the direction along the virtual axis X.

Specifically, the processor 11 causes a central portion of the boundary 71a to protrude in the direction along the virtual axis X with respect to both side portions of the boundary 71a. For example, the processor 11 causes the central portion of the boundary 71a to protrude in the positive direction of the virtual axis X when the running acceleration is a positive value, and causes the central portion of the boundary 71a to protrude in the negative direction of the virtual axis X when the running acceleration is a negative value. The protruding direction may be reversed. In the example shown in FIG. 9, as in the above embodiment, the user can also easily grasp the state of the running acceleration of the vehicle.

The number, shape, size, and position of the state display elements are not limited to those described in the above embodiments.

In the first embodiment, the predetermined region in which the state display element is displayed is circular. Alternatively, the predetermined region may be, for example, rectangular or elliptical. In the first embodiment, the state display element is located in the center of the screen. Alternatively, it may be located at another position such as a corner of the screen.

In the first embodiment, the state display element 71 includes the boundary 71a that divides the state display region 66, and in the second embodiment, the state display element is the boundary 91 that divides the background image 80. Alternatively, the state display element may not include a boundary that divides a predetermined region in the screen. For example, in the first embodiment, the state display element 71 may include only the auxiliary scale lines 71b. The state display element may include only an element that does not divide a region on the screen, such as the figure as indicated as the first reference element 74a or the straight line as indicated as the second reference element 74b.

The state display element may not be displayed as a two-dimensional object, and may be displayed as a three-dimensional object. In this case, the direction in which the virtual axis extends may have a component in a depth direction. The processing circuitry of the information display device may move the state display element in the depth direction.

The number, shape, size, and position of the reference display element are not limited to those described in the above embodiments. The reference display element may not be displayed.

For example, in the first embodiment, the one or more reference display elements 74 do not move in accordance with a change in the acceleration of the vehicle 1 and do not move in accordance with a change in the bank angle of the vehicle 1, but one or all of the reference display elements may rotationally move about the rotation center O together with the virtual axis X and the state display element in accordance with a change in the bank angle of the vehicle 1.

The reference display element may be bar-shaped. The reference display element may rotationally move together with the state display element based on the rotation angle information (see FIG. 8), or the reference display element may be fixed on the screen regardless of the rotation angle information (see FIG. 3).

In the above embodiments, the rotation angle information is information on the inclination angle of the vehicle body 4 about the front-rear axis with respect to the running surface, but the rotation angle information is not limited thereto. The rotation angle information may include information on an inclination angle of a running surface on which the vehicle runs about the front-rear axis with respect to a horizontal plane.

The vehicle may not be a motorcycle, and may be another type of straddle-type vehicle such as a bicycle or a three-wheeled motor vehicle. The vehicle is preferably a straddle-type vehicle, and may also be a vehicle other than a straddle-type vehicle, such as a four-wheeled vehicle. The vehicle may not be a land vehicle. For example, the vehicle may be a water craft or the like.

It is preferable that the body of the vehicle can be inclined with respect to the running surface. Alternatively, the vehicle may be a vehicle, such as a four-wheeled vehicle, whose body cannot be inclined with respect to the running surface. In this case, the rotation angle information related to the rotation angle about the front-rear axis of the vehicle may not be information related to the bank angle, and may be information related to the inclination of the vehicle as the vehicle runs on an inclined running surface. In other words, the rotation angle information may be information on the inclination angle of the running surface about the front-rear axis with respect to the horizontal plane.

In the above embodiments, the processing circuitry acquires the rotation angle information by calculating the bank angle, which is the rotation angle about the front-rear axis from the upright state of the vehicle body 4, based on the angular velocity detected by the gyro sensor 25. However, the rotation angle information is not limited thereto. A camera that captures an image of the running surface may be mounted on the vehicle, and the processing circuitry may acquire the rotation angle information by performing image recognition on the image captured by the camera. The gyro sensor or the camera may be adopted as a second sensor.

In the above embodiments, the processing circuitry acquires a detection value of the acceleration sensor 24 as the acceleration information related to the running acceleration of the vehicle 1. Alternatively, the acceleration information may not be the detection value of the acceleration sensor 24, and may be a parameter corresponding to the running acceleration of the vehicle 1. For example, the acceleration information may include a detection value of a throttle position sensor that detects a throttle opening degree. For example, the acceleration information may include a detection value of an accelerator position sensor that detects an accelerator operation amount. This is because acceleration of the vehicle 1 can be estimated based on the throttle opening degree or the accelerator operation amount. For example, the acceleration information may include a detection value of a brake pressure sensor that detects the brake pressure. This is because deceleration of the vehicle 1 can be estimated based on the brake pressure. These sensors may be employed as a first sensor.

In the above embodiments, the display device mounted on the vehicle is described as the information display device. Alternatively, the information display device may not be mounted on the vehicle. For example, the information display device may be a portable or stationary computer device such as a smartphone or a personal computer.

In the above embodiments, the acceleration information and the rotation angle information acquired by the processing circuitry of the information display device 10 indicate real-time information on the acceleration and the rotation angle of the vehicle 1. Alternatively, the acceleration information and the rotation angle information may be information obtained by running the vehicle in the past. That is, the information display device is not limited to one that shows the state of the vehicle during current running, but may also show the state of the vehicle during the past running.

As described above, the above-described embodiments have been described as examples of the technique disclosed in the present application. However, the technique disclosed in the present disclosure is not limited thereto, and is also applicable to embodiments in which changes, replacements, additions, omissions, and the like are appropriately performed. In addition, it is also possible to combine constituent elements described in the above-described embodiments to provide a new embodiment. For example, a part of a configuration or a method in one embodiment may be applied to another embodiment, and a part of a configuration in one embodiment may be freely separated and extracted from another configuration in the embodiment. Further, the constituent elements described in the accompanying drawings and the detailed description include not only constituent elements essential for solving the problem but also constituent elements that are not essential for solving the problem in order to illustrate the technique. Two blocks shown in sequence in the flowchart may be executed at the same time or in reverse order depending on the circumstances.

The functions of the elements disclosed in the present specification can be executed by using a general-purpose processor, a dedicated processor, an integrated circuit, an application specific integrated circuits (ASIC), a field programmable gate array (FPGA), a circuit of the related art, and/or a circuit or a processing circuitry that includes a combination thereof, which are configured or programmed to execute the disclosed functions. Since the processor includes a transistor and other circuits, the processor is regarded as a processing circuitry or a circuit. In the present disclosure, a circuit, a unit, or means is hardware that executes the listed functions or hardware that is programmed to execute the listed functions. The hardware may be hardware disclosed in the present specification, or may be other known hardware that is configured or programmed to execute the listed functions. When the hardware is a processor considered to be a type of circuit, the circuit, the means, or the unit is a combination of hardware and software, and the software is used for the configuration of the hardware and/or the processor.

The following aspects each disclose a preferred embodiment.

### Aspect 1

An information display device includes: a display; and a processing circuitry configured to control display of a screen on the display, in which the processing circuitry is configured to: acquire acceleration information related to acceleration in a traveling direction of a vehicle; acquire rotation angle information related to a rotation angle about a front-rear axis of the vehicle; display a state display element indicating states of both the acceleration and the rotation angle in a predetermined region of the screen; move or deform the state display element in a predetermined direction based on the acceleration information; and rotationally move the state display element based on the rotation angle information.

According to the Aspect 1, both the acceleration and the rotation angle about the front-rear axis of the vehicle are displayed on the screen by the state display element, so that the screen of the display can be prevented from becoming cluttered as compared with a case where the acceleration of the vehicle and the rotation angle about the front-rear axis of the vehicle are separately displayed. According to the Aspect 1, on the screen, the acceleration of the vehicle is represented by the movement or deformation of the state display element in the predetermined direction, and the rotation angle about the front-rear axis of the vehicle is represented by the rotation of the state display element, so that the user can intuitively grasp the state of the vehicle from the changes in the state display element.

### Aspect 2

In the information display device according to the Aspect 1, the predetermined direction is a direction along a predetermined virtual axis extending linearly, and rotationally moving the state display element is to rotationally move the virtual axis and the state display element.

According to the Aspect 2, the user can more easily grasp the state of the acceleration of the vehicle and the state of the rotation angle about the front-rear axis of the vehicle.

### Aspect 3

In the information display device according to the Aspect 2, moving or deforming the state display element in the direction along the virtual axis is to move the state display element in the direction along the virtual axis, and rotationally moving the virtual axis and the state display element includes rotationally moving the virtual axis and the state display element about a predetermined point through which the virtual axis passes.

According to the Aspect 3, the user can more easily grasp the state of the acceleration of the vehicle and the state of the rotation angle about the front-rear axis of the vehicle.

### Aspect 4

In the information display device according to any one of the Aspects 1 to 3, the state display element includes a linear element, the linear element is a straight line when the acceleration is zero, and moving or deforming the state display element in the predetermined direction includes protruding a central portion of the linear element in the predetermined direction with respect to both side portions of the linear element.

According to the Aspect 4, the user can more easily grasp the state of the acceleration of the vehicle.

### Aspect 5

In the information display device according to any one of the Aspects 1 to 4, the state display element includes a boundary that divides the predetermined region of the screen into a first region and a second region.

According to the Aspect 5, both the acceleration and the rotation angle about the front-rear axis of the vehicle can be expressed by simple elements.

### Aspect 6

In the information display device according to the Aspect 5, the processing circuitry is configured to display the first region and the second region in different colors with each other.

According to the Aspect 6, the state of the acceleration of the vehicle can be grasped from the size of the area of the region, so that it is easy to grasp the state of the acceleration of the vehicle.

### Aspect 7

In the information display device according to any one of the Aspects 1 to 6, the predetermined region is a circle, and a rotation center of a rotational movement of the state display element is a center of the circle.

According to the Aspect 7, it is easy to visually distinguish the state display element from other display elements on the screen.

### Aspect 8

In the information display device according to any one of the Aspects 1 to 7, the vehicle is configured such that a body is inclinable with respect to a running surface on which the vehicle runs, and the rotation angle information includes information on an inclination angle of the body about the front-rear axis with respect to the running surface.

According to the Aspect 8, the user can grasp the state of the rotation angle about the front-rear axis of the vehicle.

### Aspect 9

In the information display device according to any one of the Aspects 1 to 7, the rotation angle information includes information on an inclination angle of a running surface on which the vehicle runs about the front-rear axis with respect to a horizontal plane.

According to the Aspect 9, the user can grasp the inclination of the running surface.

### Aspect 10

In the information display device according to any one of the Aspects 1 to 9, the predetermined region is located in a center of the screen.

According to the Aspect 10, it is easy to visually recognize the state display element.

### Aspect 11

In the information display device according to any one of the Aspects 1 to 10, the processing circuitry is configured to: acquire rotation speed information indicating a rotation speed of a driving source for running of the vehicle; and display a display element indicating the rotation speed in an outer periphery region extending along an outer periphery of the predetermined region based on the rotation speed information.

According to the Aspect 11, it is possible to effectively use a region around the region where the state display element is displayed on the screen.

### Aspect 12

In the information display device according to any one of the Aspects 1 to 11, the predetermined region is displayed as a background image of the screen, and the processing circuitry is configured to: acquire vehicle parameter information indicating a parameter related to the vehicle other than the acceleration and the rotation angle; and superimpose and display the vehicle parameter information on the background image.

According to the Aspect 12, it is possible to display the state of the acceleration of the vehicle and the state of the rotation angle about the front-rear axis of the vehicle while securing a sufficient region for displaying the vehicle parameters.

### Aspect 13

In the information display device according to any one of the Aspects 1 to 12, the processing circuitry is configured to display, on the screen, a reference display element indicating a position of the state display element when the acceleration is zero, and moving or deforming the state display element in the predetermined direction includes: positioning the state display element at the reference display element when the acceleration is zero; moving the state display element to one side from the reference display element when the acceleration is a positive value; and moving the state display element to the other side from the reference display element when the acceleration is a negative value.

According to the Aspect 13, it is possible to determine whether the vehicle is accelerating, decelerating, or running at a constant speed based on a positional relationship between the state display element and the reference display element.

### Aspect 14

In the information display device according to the Aspect 13, the processing circuitry is configured to rotationally move the reference display element together with the state display element based on the rotation angle information.

According to the Aspect 14, the reference display element rotates together with the state display element, so that it is easier to grasp the state of the acceleration of the vehicle from the positional relationship between the state display element and the reference display element.

### Aspect 15

In the information display device according to any one of the Aspects 1 to 14, the processing circuitry is configured to: display, on the screen, a rotation angle scale arranged along a rotation direction of the state display element and an indicator element indicating a position corresponding to the rotation angle about the front-rear axis of the vehicle in the rotation angle scale; and rotationally move at least one of the indicator element or the rotation angle scale together with the state display element based on the rotation angle information.

According to the Aspect 15, it is easy to grasp the rotation angle about the front-rear axis of the vehicle.

### Aspect 16

In the information display device according to any one of the Aspects 1 to 15, the state display element is displayed as a three-dimensional object, and moving or deforming the state display element in the predetermined direction includes moving the state display element in a depth direction.

According to the Aspect 16, the user can more intuitively grasp whether the vehicle is accelerating.

### Aspect 17

A vehicle is configured to incline a body in a turning direction when turning, and the vehicle includes: the body; a first sensor fixed to the body and configured to detect information related to acceleration in the traveling direction of the vehicle; a second sensor fixed to the body and configured to detect information related to a rotation angle about the front-rear axis of the vehicle; and the information display device according to any one of the Aspects 1 to 16 fixed to the body.

What is claimed is:

1. An information display device comprising:
a display; and
a processing circuitry configured to control display of a screen on the display, wherein
the processing circuitry is configured to:
acquire acceleration information related to acceleration in a traveling direction of a vehicle;
acquire rotation angle information related to a rotation angle about a front-rear axis of the vehicle;
display a state display element indicating states of both the acceleration and the rotation angle in a predetermined region of the screen;
move or deform the state display element in a predetermined direction based on the acceleration information; and
rotationally move the state display element based on the rotation angle information.

2. The information display device according to claim 1, wherein
the predetermined direction is a direction along a predetermined virtual axis extending linearly, and
rotationally moving the state display element is to rotationally move the virtual axis and the state display element.

3. The information display device according to claim 2, wherein
moving or deforming the state display element in the direction along the virtual axis is to move the state display element in the direction along the virtual axis, and
rotationally moving the virtual axis and the state display element includes rotationally moving the virtual axis and the state display element about a predetermined point through which the virtual axis passes.

4. The information display device according to claim 1, wherein
the state display element includes a linear element,
the linear element is a straight line when the acceleration is zero, and
moving or deforming the state display element in the predetermined direction includes protruding a central portion of the linear element in the predetermined direction with respect to both side portions of the linear element.

5. The information display device according to claim 1, wherein
the state display element includes a boundary that divides the predetermined region of the screen into a first region and a second region.

6. The information display device according to claim 5, wherein
the processing circuitry is configured to display the first region and the second region in different colors with each other.

7. The information display device according to claim 1, wherein
the predetermined region is a circle, and
a rotation center of a rotational movement of the state display element is a center of the circle.

8. The information display device according to claim 1, wherein
the vehicle is configured such that a body is inclinable with respect to a running surface on which the vehicle runs, and
the rotation angle information includes information on an inclination angle of the body about the front-rear axis with respect to the running surface.

9. The information display device according to claim 1, wherein
the rotation angle information includes information on an inclination angle of a running surface on which the vehicle runs about the front-rear axis with respect to a horizontal plane.

10. The information display device according to claim 1, wherein
the predetermined region is located in a center of the screen.

11. The information display device according to claim 1, wherein
the processing circuitry is configured to:
acquire rotation speed information indicating a rotation speed of a driving source for running of the vehicle; and
display a display element indicating the rotation speed in an outer periphery region extending along an outer periphery of the predetermined region based on the rotation speed information.

12. The information display device according to claim 1, wherein
the predetermined region is displayed as a background image of the screen, and
the processing circuitry is configured to:
acquire vehicle parameter information indicating a parameter related to the vehicle other than the acceleration and the rotation angle; and
superimpose and display the vehicle parameter information on the background image.

13. The information display device according to claim 1, wherein
the processing circuitry is configured to display, on the screen, a reference display element indicating a position of the state display element when the acceleration is zero, and
moving or deforming the state display element in the predetermined direction includes:
positioning the state display element at the reference display element when the acceleration is zero;
moving the state display element to one side from the reference display element when the acceleration is a positive value; and
moving the state display element to the other side from the reference display element when the acceleration is a negative value.

14. The information display device according to claim 13, wherein
the processing circuitry is configured to rotationally move the reference display element together with the state display element based on the rotation angle information.

15. The information display device according to claim 1, wherein
the processing circuitry is configured to:
display, on the screen, a rotation angle scale arranged along a rotation direction of the state display element and an indicator element indicating a position corresponding to the rotation angle about the front-rear axis of the vehicle in the rotation angle scale; and
rotationally move at least one of the indicator element or the rotation angle scale together with the state display element based on the rotation angle information.

16. The information display device according to claim 1, wherein
the state display element is displayed as a three-dimensional object, and
moving or deforming the state display element in the predetermined direction includes moving the state display element in a depth direction.

17. A vehicle that is configured to incline a body in a turning direction when turning, the vehicle comprising:
the body;
a first sensor fixed to the body and configured to detect information related to the acceleration in the traveling direction of the vehicle;
a second sensor fixed to the body and configured to detect information related to the rotation angle about the front-rear axis of the vehicle; and
the information display device according to claim 1, fixed to the body.
